(19) United States
(12) Patent Application Publication
(10) Pub. No.: US 2003/0067385 A1
(43) Pub. Date: Apr. 10, 2003

(54) Motion sensor device

(76) Inventors: Eric Shank, San Francisco, CA (US); Terry Cyr, San Francisco, CA (US); Tricia Lee Wright, San Francisco, CA (US); Christopher L. Myers, San Francisco, CA (US)

Correspondence Address: FROST BROWN TODD LLC, 2200 PNC Center, 201 E. Fifth Street, Cincinnati, OH, 45202-4182, US

(21) Appl. No.: 10/238,501

(22) Filed: Sep. 10, 2002

Related U.S. Application Data
(60) Provisional application No. 60/318,658, filed on Sep. 10, 2001.

(51) Int. Cl. G08B 1/08

(52) U.S. Cl. 340/539; 340/541

(57) ABSTRACT

A motion sensor system is provided that has several sensor units. Each sensor unit is freely movable, easily hidden and includes a motion sensor and a wireless radio frequency (RF) transmitter. The motion sensor system further includes a receiver unit, which includes a wireless radio frequency receiver and a device for communicating receipt of a signal to the user. When at least one of the motion sensors of at least one of the sensor units detects motion, the wireless radio frequency transmitter transmits a signal to the radio frequency receiver of the receiver unit. The receiver unit then communicates receipt of the signal to the user.

### TECHNICAL FIELD

The present invention relates generally to a toy for children, and is particularly directed to a motion sensor spy toy system for children.

### BACKGROUND OF THE INVENTION

Children often enjoying playing games that involve pretending to be involved in some kind of covert operation. To that end toy manufacturers have introduced a variety of toys including walkie-talkies, toy binoculars, various objects with secret compartments for hiding things, among other toys. Unlike known prior art devices, the present invention is a spy toy system where a user can place motion sensors in a given area and monitor the movement of their “targets”.

### SUMMARY OF THE INVENTION

Accordingly, it is object of the present invention to provide a motion sensor system that has one or more sensor units. Each sensor unit is freely movable, easily hidden and is comprised of a motion sensor and a wireless radio frequency (RF) transmitter. The motion sensor system further includes a receiver unit, which is comprised of wireless radio frequency receiver and a means for communicating receipt of a signal to the user. When at least one of the motion sensors of at least one of the sensor units detects motion, the wireless radio frequency transmitter transmits a signal to the radio frequency receiver of the receiver unit. The receiver unit then communicates receipt of the signal to the user.

### BRIEF DESCRIPTION OF THE DRAWING

FIG. 1 is a perspective view of the Motion Sensor Device.

### DETAILED DESCRIPTION OF THE PREFERRED EMBODIMENT

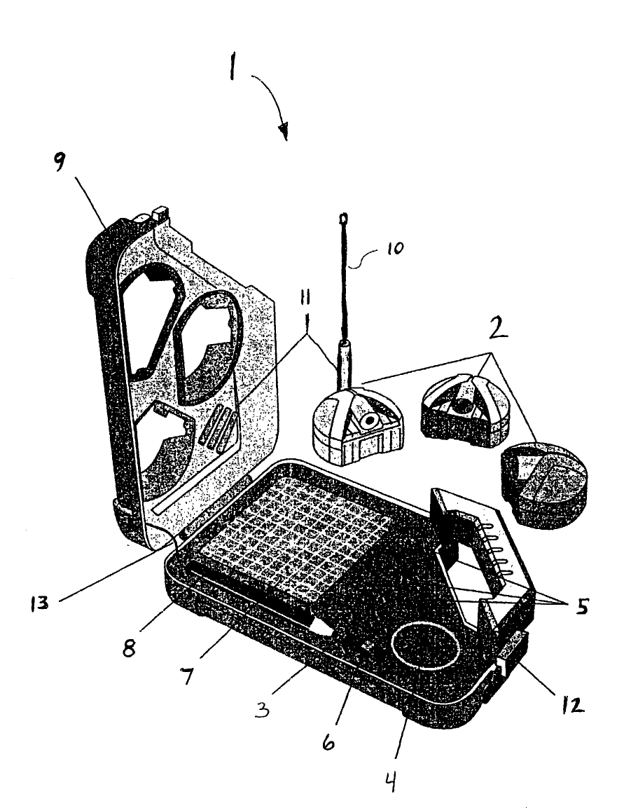

Reference will now be made in detail to the present preferred embodiment of the invention, an example of which is illustrated in the accompanying drawing wherein like numerals indicate the same elements throughout the views. Referring now to the drawing, FIG. 1 shows the toy motion sensor system of the present invention, generally designated by the numeral 1.

As shown in FIG. 1, the sensor system includes one or more sensor units 2, preferably no more than five and more preferably three (as shown in FIG. 1). Each sensor unit 2 has a built in motion sensor and a wireless radio frequency (RF) transmitter. Both the motion sensor and wireless radio frequency (RF) transmitter are preferably of the type known in the art and which are generally commercially available. The motion sensor and transmitter are configured such that when a motion detected by the motion sensor, the transmitter generates a signal. In the preferred embodiment, the wireless radio frequency (RF) transmitter of each sensor unit transmits on a frequency that is unique to each sensor. Each sensor unit 2 is preferably battery powered and each may include a power switch that allows them to be turned on and off. Further, the sensor units 2 can be of a variety of shapes, sizes and colors. Preferably, the sensor units will occupy a volume of no more than five cubic inches, so that they are easily hidden, and will have a flat bottom, domed top and a flat face where the motion sensor is set. The sensor units 2 can be comprised of any suitable durable material, preferably a durable engineering thermoplastic. Each sensor unit 2 is preferably of a neural color, like gray, so that it is easily concealed.

Further, it is preferred that each motion sensor unit 2 has a semi-flexible antenna 10 connected to the wireless radio frequency transmitter to aid in transmitting the signal. It is also preferred that the domed top of each sensor unit 2 is configured such that an antenna tube 11 can be removably attached to the sensor unit 2. The antenna tube 11 assists in holding the semi-flexible antenna 10 upright by threading the semi-flexible antenna 10 through the antenna tube 11 and then securing the tube to the sensor unit 2. It is preferred that the antenna tube 11 is comprised of the same material as the sensor unit 2 and is of similar color.

The sensor system also includes a receiver unit 3. The receiver unit is mainly comprised of a wireless radio frequency (RF) receiver and a means for communicating to the user the receipt of a signal from a sensor unit. The user can be notified of receipt of the signal any number of ways including an audio alert, visual alert, vibration, or a combination thereof. In the preferred embodiment, the user can be notified by an audio signal through a speaker 4 and LED lights that correspond to the sensor unit sending the signal 5. The receiver unit is preferably battery powered, and preferably has a switch 6 that allows the unit to be powered on, off, or set in “mute” mode where the speaker 4 is muted and the user is only notified via the LED lights 5 of receipt of a signal from a sensor unit 2.

In the preferred embodiment, the receiver unit 3 also has a grid 7 where the user can draw a sketch of the area where the sensor units 2 have been placed. A writing instrument 8, like a grease pencil or dry erase marker, is removably attached to the receiver unit for use by the user in sketching on the grid 7. The grid 7 is made of any durable material, preferably a durable engineering plastic and is smooth such that markings from the writing instrument 8 are easily removed.

In the preferred embodiment, the receiver unit 3 also has a lid 9 hingably attached and configured such that the sensor units 2 can be releasably secured to the receiver unit 3 for storage. It is also preferred that the lid 9 is configured such that the antenna tubes 11 can also be releaseably secured to the lid 9 for storage. An antenna for the wireless radio frequency receiver 13 is preferably secured to the interior portion of the lid 9. The lid 9 is preferably held in a closed position by a latch 12. The receiver unit 3 and the lid 9 can be made of any durable material, preferably a durable engineering plastic.

### Method of Use

In order to use the device of the present invention, a user would first remove each sensor unit 2 from the lid 9. Next, a user would remove each antenna tube 11 from the lid 9 and then thread the semi-flexible antenna 10 of each sensor unit 2 through an antenna tube 11. A user would then secure the antenna tube 11 atop each sensor unit 2 and move the switch of each sensor unit 2 to an on position. Next, a user would hide each sensor unit 2 in the desired area. With the writing instrument 8, the user may then sketch on the grid 7 where each sensor unit 2 has been hidden. The user next switches the receiver unit 3 on or to “mute” mode. When the motion sensor of a sensor unit 2 detects motion, a signal will be transmitted on a frequency that is unique to the sensor unit 2 to the receiver unit 3. The receiver unit 3 will notify the user as to which sensor unit 2 has detected motion through the LED light 5 that corresponds to the sensor unit 2 transmitting the signal and by audio signal via the speaker 4 (if not in “mute” mode).

What is claimed is:

1. A motion sensor system comprising:
(a) one or more sensor units, each of said motion sensor units comprising a motion sensor and a wireless radio frequency (RF) transmitter, where said sensor units are adapted to be freely movable and easily hidden; and
(b) a receiver unit comprising a wireless radio frequency (RF) receiver and a means for communicating receipt of a signal to the user;
wherein when at least one of said motion sensors of said one or more sensor units detects motion, said wireless radio frequency transmitter transmits a signal to said radio frequency receiver of said receiver unit and said receiver unit communicates the receipt of the signal to the user.
